(19) United States
(12) Patent Application Publication
(10) Pub. No.: US 2015/0330105 A1
(43) Pub. Date: Nov. 19, 2015

(54) SELF-LOCKING LOCKBOX WITH MECHANICAL PUSH BUTTON COMBINATION LOCK

(71) Applicants: Kwan Yuen NG, El Monte, CA (US); Sarah NG, El Monte, CA (US); Tsz Yueng CHAN, El Monte, CA (US); Caron NG, El Monte, CA (US)

(72) Inventors: Kwan Yuen NG, El Monte, CA (US); Sarah NG, El Monte, CA (US); Tsz Yueng CHAN, El Monte, CA (US); Caron NG, El Monte, CA (US)

(21) Appl. No.: 14/276,696

(22) Filed: May 13, 2014

(51) Int. Cl. E05B 37/00

(52) U.S. Cl. CPC E05B 37/0068

(57) ABSTRACT

The present invention generally relates to lockboxes. More particularly, the invention relates to a mechanical pushbutton combination lockbox which is designed to self-lock such that an additional input or locking action is not required to lock the lockbox when closed.

### CROSS-REFERENCE TO RELATED APPLICATIONS

This application claims the benefit under 35 U.S.C. §119(e) of U.S. utility patent application Ser. No. 14/248,605, entitled “Self-Locking Lockbox System and Method” filed on Apr. 9, 2014, the contents of the aforementioned application is hereby incorporated by reference in its entirety.

### FIELD OF THE INVENTION

The present invention generally relates to lockboxes. More particularly, the invention relates to a lockbox which is designed to self-lock and reset a manual push button combination lock such that an additional locking action is not required by the user to lock the lockbox when closed.

### BACKGROUND

Lockboxes are commonly used in the real estate sales industry to provide a means for a large number of salesmen to conveniently gain access to locked buildings. A typical lockbox includes an inner repository that can be used to store a key to a building. The inner repository of the lockbox can be accessed by opening a lockable door attached to the lockbox. A combination locking mechanism can be used to enable the door to be lockable and limit access to the inner repository. In this manner, individuals having the combination to the combination lock will have access to the key in the inner repository, thereby having access to the locked building.

A number of lockbox designs have been developed. U.S. Pat. No. 5,815,557 issued to Larson discloses a secure entry system that makes use of radio transmissions to communicate with locks, keys, and related components throughout the system. The radio transmissions can be made using a paging system, a cellular telephone system, or any other RF carrier. Some embodiments employ a cellular telephone in lieu of an electronic key. Others integrate a paging receiver within an electronic key to provide a unit with dual functionality. The system is illustrated with reference to exemplary application in the industrial site security, real estate lockbox, and transportation fields. A homeowner key allows the homeowner greater oversight and involvement. The key includes a privacy feature, enabling the homeowner to disable the lockbox for a predetermined period if privacy is desired.

U.S. Pat. No. 4,727,368 issued to Larson, et al. describes real estate lockbox and key designs which provide a variety of operational features. Also disclosed is a comprehensive system that allows real estate boards and agencies to efficiently manage their lockbox operations. Features provided by the system include the ability to record all accesses to all lockboxes; transfer all or part of such records from the lockboxes to the real estate agency or board; organize and review such records at the agency or board offices; disable operation of various lockboxes during certain hours of the day; facilitate operation of lockboxes that are mounted in awkward or poorly lit locations; limit lockbox accesses to pre-selected agents, agencies or boards; and record diagnostic information with each operation of a lockbox or key.

U.S. Pat. No. 6,813,912 issued to Ng, et al. describes a secure lockbox that includes an interior key lock controlling access to the mechanism for setting and changing the combination for the lock controlling access to the interior storage compartment of the lockbox. A second key lock controls the attachment bail of the lockbox, preventing unauthorized removal of the lockbox. The two key locks may be identically keyed. In a variant of the invention, a second combination lock controls the attachment bail instead of a key lock. Resilient coverings are provided for the attachment bail and the sides of the lockbox body to prevent damage to buildings and fixtures. A chain is provided to secure the door of the lockbox to the body. A slide latch having non-slip features is controlled by the door's combination lock and engages an edge of the door opening to secure the door opening.

While various improvements have been made to these traditional lockboxes over the years, certain disadvantages still remain. For example, once the lockbox is open by way of entering a combination into the combination locking mechanism the lockbox will remain open until the user of the lockbox has reentered the combination into the combination lock to enable the door to lock. Moreover, it is desirable to be able to close the lockable door whereby when the lockable door is closed the lockbox is locked without reentry of a combination. Additionally, often times the user forgets their combination or forgets to reenter their combination to relock the door. When the combination is not reentered the door is not able to fully close and lock. This enables anyone to open the lockbox and retrieve the contents.

Additionally, the industry has driven lockboxes to incorporate microprocessors and advanced communication methods to enable remote connectivity. Although these have benefits they also add security issues as unauthorized users hack the software to enable unauthorized access.

Given the deficiencies described above, there exists an unfulfilled need for an improved lockbox system that addresses the various disadvantages inherent to lockboxes found in the prior art.

### SUMMARY

According to one exemplary embodiment of the present invention, a mechanical lockbox system is provided that includes a smartly designed lockable door and when the lockable door of the lockbox is pushed closed the lockable door is locked such that an additional locking action or reentry of a combination is not required to lock the lockbox when closed.

According to another embodiment of the present invention, the lockbox consists of a body and a lockable door whereby the lockable door includes a combination locking mechanism. When opened the lockable door exposes an inner repository within the body. Furthermore, the lockable door includes a latching system that enables the lockable door to open by applying pressure to the locking end of the lockable door.

According to another embodiment of the present invention, the lockable door includes a locking latch securing mechanism that will temporarily hold the latching system such that when the latching system is operated to open, the locking latch securing mechanism temporarily holds the locking latch such that the lockable door clears the body and opens.

According to an additional embodiment of the present invention, the latching system of the lockable door can be interconnected with a mechanical push button combination locking mechanism such that the latching system resets the combination locking mechanism to lock when the lockable door is pushed closed thereby locking the lockable door and requiring a combination to be entered to open.

### BRIEF DESCRIPTION OF THE DRAWINGS

The accompanying drawings, which are incorporated into and constitute a part of this specification, illustrate one or more embodiments, and together with the detailed description, serve to explain the principles and implementation of the invention. Additionally when reviewing the drawings as a whole, phases of the self-locking lockbox are disclosed and such conditions include a closed and locked condition, unlocked condition and an open condition. The closed configuration is illustrated in FIGS. 1 and 2, the unlocked configuration is represented in FIGS. 3 and 4 and the open configuration is illustrated in FIG. 5.

FIG. 1 illustrates an exemplary embodiment of a lockbox according to the present invention.

FIG. 2 is an exemplary embodiment of the latching system of the lockable door in closed configuration according to the present invention.

FIG. 2a represents an embodiment of a mechanical push button combination locking mechanism of the present invention.

FIG. 2b represents an embodiment of the mechanical push button combination locking mechanism in recessed mode.

FIG. 3 illustrates an exemplary embodiment of the opposing latches and locking latch securing mechanism whereby the securing rod is deployed holding the locking latch in place.

FIG. 4 illustrates the locking latch securing mechanism while the locking latch is in an unlocked condition.

FIG. 5 depicts an exemplary embodiment of the securing rod, the securing block and the locking latch in a locked condition as the lockable door is opened.

FIG. 6 is a flow chart illustrating the process in which the self-locking lockbox is unlocked and the mechanical pushbutton combination mechanism is reset.

### DETAILED DESCRIPTION

Exemplary Embodiments are described herein in the context of a self-locking lockbox system. Those of ordinary skill in the art will realize that the following detailed description is illustrative only and is not intended to be in any way limiting. Other embodiments of the present invention will readily suggest themselves to such skilled persons having the benefit of the disclosure. Reference will now be made in detail to implementations of embodiments of the present invention as illustrated in the accompanying drawings. The same reference indicators will be used throughout the drawings and the following detailed description to refer to the same or like parts.

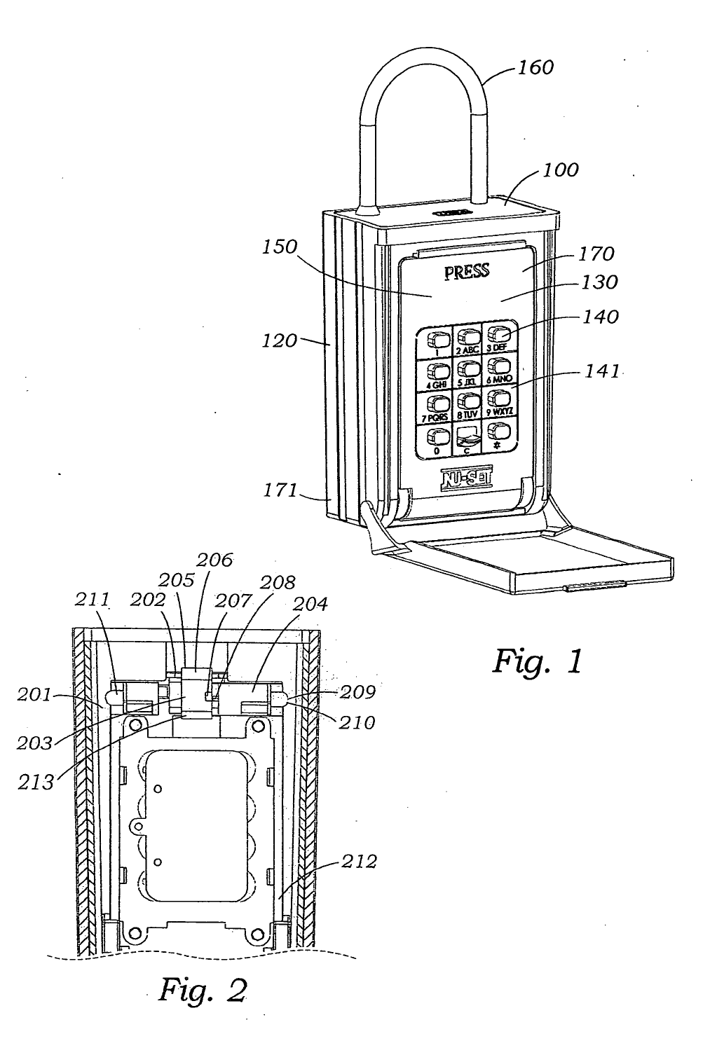

Referring to FIG. 1, an embodiment of self-locking lockbox 100 can generally be seen as including a body 120 and a lockable door 130. The lockable door 130 having a latching system (not shown) and a locking end 170 whereby the latching system is located at the locking end 170 of the lockable door 130. The lockable door 130 also includes a hinged end 171 whereby the hinged end 171 is rotatable and secured to the body 120 of the self-locking lockbox 100. The lockable door 130 includes a combination locking mechanism 140 which is located towards the hinged end 171 and a flat surface 150 located towards the locking end 170 whereby the flat surface 150 enables a surface whereby a user may push the locking end 170 to unlock and open the lockable door 130 after entering their combination.

In this embodiment of the invention, attachment bail 160 is U-shaped and extends away from the top surface 170 of the body 120. Attachment bail 160 is slidable from a first open position to a second closed position in which lockbox 100 can be secured to a building structure. As with other conventional combination padlocks, combination locking mechanism 141 and key locks can be used to secure attachment bail 160 to body 120 in the closed position.

Additionally, in the present embodiment where the combination lock mechanism 140 includes a mechanical keypad 141 a user may input a combination to initiate the unlocking process.

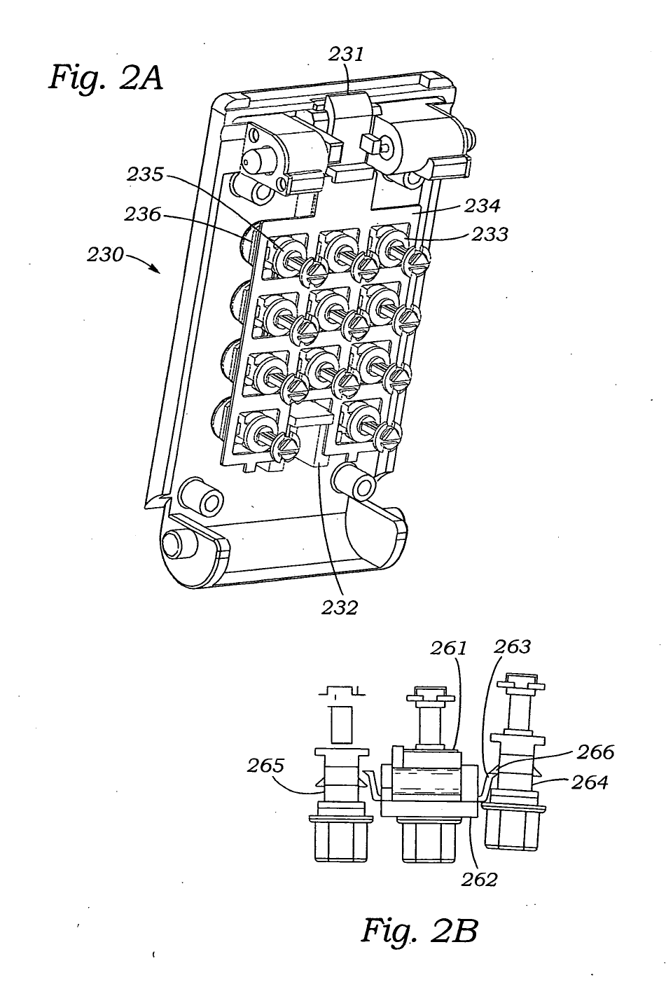

Referring now to FIG. 2, which illustrates the rear view of the lockable door 201, as if it was in the closed and locked configuration within the body and includes a latching system 202, and locking latch securing mechanism 204. Additionally, the latching system 202 includes a locking latch 203 that has a securing block 207 whereby the securing block 207 is a part of or fixed to the locking latch 203. The securing end 206 of the locking latch 203 has a beveled edge 205 and a flat edge (not-shown) such that, among other things, when closing the lockable door 201 the beveled edge 205 causes to the locking latch 203 to slide towards the hinged end 212 of the lockable door 201 enabling the locking latch 203 along with the lockable door 201 ingress to the body (not shown) as it clears the locking plate (not shown). The opposite side of the securing end 206 is the attaching end 211 which is designed to attach to a combination locking mechanism such that when a combination is correctly entered into the combination locking mechanism the locking latch 205 is free to slide towards the hinged end 212 of the lockable door 201.

Another innovative aspect of the present invention is realized when referring to FIG. 2a, which represents a mechanical push button combination locking mechanism working in conjunction with a locking latch such that the locking latch 231 resets the mechanical push button combination locking mechanism 230 when opened without additional action by the user. More specifically, the mechanical push button combination locking mechanism 230 includes a plurality of push buttons and associated push button camshafts whereby each push button camshaft includes a key which is enabled to rotate to set a combination required to open the lockable door. Also, the mechanical push button combination locking mechanism 230 includes button locking rails 232 which are smartly designed to hold a push button (not shown) and the associated push button camshaft 233 in recessed mode once depressed by a user when entering a combination. The mechanical push button combination locking mechanism 230 includes a restricting plate 234. The restricting plate 234 and the button locking rails 232 are slidably adjacent to each other and reference the same surface of the locking latch 231 such that the button locking rails 232 and the restricting plate 234 must be free to slide towards the hinged end of the lockable door thereby enabling the locking latch 231 to slide towards the hinged end of the lockable door. The mechanical push button combination locking mechanism 230 as represented in FIG. 2a is in the locked configuration and the combination has not been entered. In FIG. 2a the push button cam shaft #1 235 is rotated whereby the remaining plurality of push button camshafts are not rotated. Rotating the push button camshaft presents a blocking surface to the restricting plate 234 such that the restricting plate 234 is not able to slide towards the hinged end of the lockable door.

As further represented in FIG. 2b, the button locking rails 261 are designed with a locking arm 262 which extend outwardly away from the button locking rails 261 and end with a beveled edge 263. The button camshaft is further represented in FIG. 2b, in recessed mode 264 and non-recessed mode 265. The button camshaft (FIG. 2a: 235) includes a beveled tab 266 which extends towards the button locking rails 26l such that when in recessed mode 264 the beveled edge 263 of the locking arm 262 can hold the beveled tab 266. When a push button camshaft has been rotated to present a blocking surface to the restricting plate placing the push button camshaft in recessed mode (FIG. 2a: 236) it presents an opened surface to the restricting plate (FIG. 2a: 234) enabling the restricting plate to slide towards the hinged end of the lockable door. As the restricting plate (FIG. 2a: 234) and the button locking rails (FIG. 2a: 232) slide towards the hinged end of the lockable door the locking arm 262 slides away from the beveled tab 266 such that the locking arm 262 can no longer hold the beveled tab 266 and the spring loaded push button camshaft returns to non-recessed mode 265 thereby resetting the combination without resetting action by the user.

The locking latch securing mechanism 204 is another particularly innovative aspect of the present invention as embodied in FIG. 2, where the locking latch securing mechanism 204 is attached to the lockable door 201 and includes a securing rod 210 that extends outwardly on each side of locking latch securing mechanism 204 where the securing end 208 of the securing rod 210 extends towards the locking latch 203 and the referencing end 211 of the securing rod 210 extends towards a wall of the body 209. The locking latch securing mechanism 204 is configured such that when in closed configuration the referencing end 211 of the securing rod 210 is spring operably compressed into the locking latch securing mechanism 204 by the body wall 209 thereby placing lateral force towards the securing end 208 of the securing rod. The securing end 208 of the securing rod is configured such that a spring operably caries the lateral pressure to the securing end 208 of the securing rod causing pressure between the securing end 208 and the securing block 207.

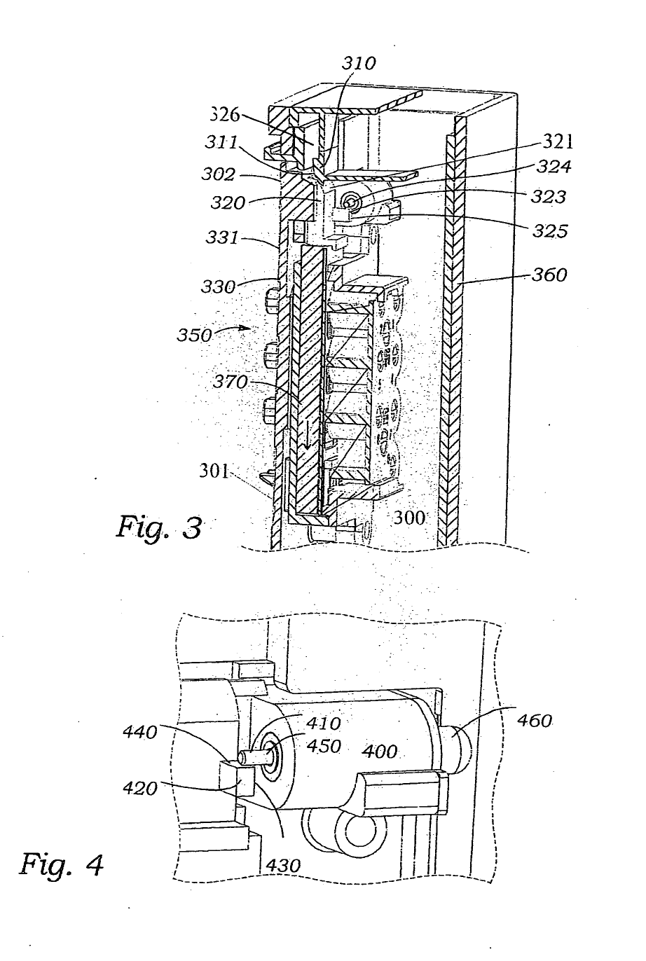

Providing a driving latch 310 is another important aspect of the present invention as embodied and represented in FIG. 3. The driving latch 310 also includes a beveled edge 311 and is securely fastened to the body 360 of the self-locking lockbox. The beveled edge 311 of the driving latch 310 counter opposes the beveled edge of the locking latch 320. While opening the self-locking lockbox, the beveled edge 311 of the driving latch 310 makes contact with the beveled edge 321 of the locking latch 320. Additionally, as a user pushes the flat surface 330 of the lockable door 331, subsequent to entering the correct combination, they generate a lateral force 350 that drives the beveled edge 320 of the locking latch 320 into the beveled edge 311 of the driving latch 310. Since the driving latch 310 is securely fastened to the body 360 and counter opposed, the beveled edges of the opposing latches translated the lateral force 350 into a vertical force 370 such that they overcome the counter spring force generated by the locking latch spring (not shown) configured to keep the locking latch 320 at the locking end 302 and in a locked condition and thereby driving the locking latch 320 to slide toward the hinged end 301 of the lockable door 331. Upon the locking latch 320 sliding at a distance whereby the locking latch 322 clears the securing plate 326, the securing block 323 is spaced such that the securing end 324 of the securing rod clears the one side of the securing block 323. As represented further in FIG. 4, once the securing end 410 of the securing rod 450 clears the one side of the securing block 430, by spring force the securing rod extends further and above the securing block 420 thereby restricting the securing block 420 and the locking latch from sliding back towards the locking end (FIG. 3: 302) of the lockable door (FIG. 3: 331).

As further represented in FIG. 4, the securing rod 450 extends further and above the securing block 420 by way of spring force which is created by a common die spring (not shown) that resides within the locking latch securing mechanism 400. The base of the die spring is relationally connected to the compressed referencing end 460 of the securing rod 450. Upon releasing the compressed referencing end 460 of the securing rod 450 the locking latch securing mechanism is designed such that the spring force of the referencing end 460 of the securing rod 450 will overcome the spring force of the securing end 410 of the securing rod 450 thereby retracting the securing end 410 away from the securing block 410 such that the securing block 420 and the locking latch (not shown) is no longer restricted from sliding back towards the locking end of the lockable door.

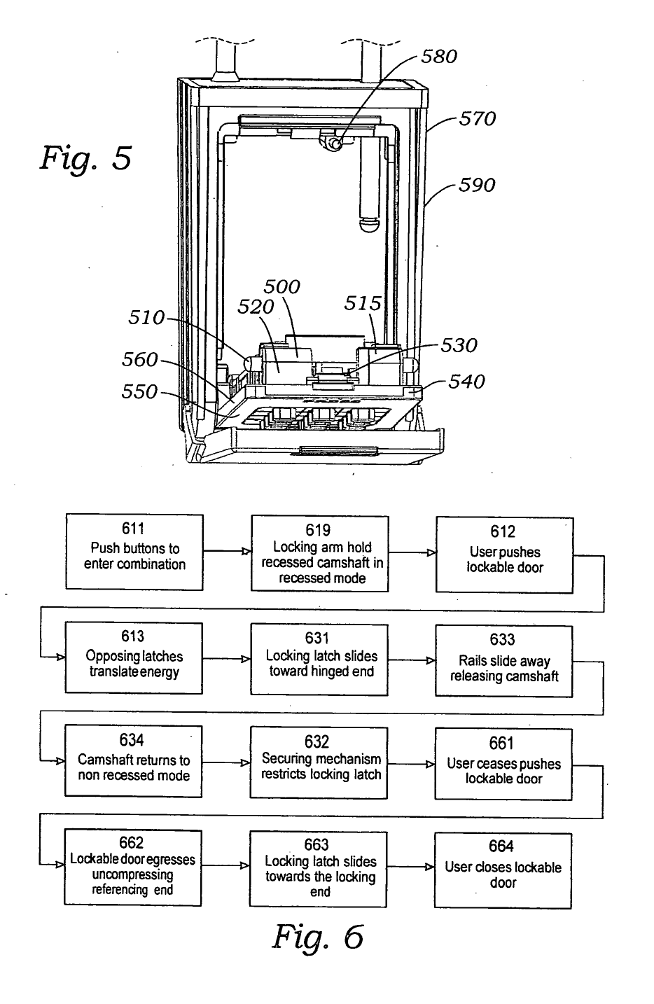

As represented in FIG. 5, in an open configuration, the released compressed referencing end 510 of the locking latch securing mechanism 500, releases the locking latch 530 such that the locking latch 530 slides towards the locking end 540 of the lockable door 560 such that it is prepared to lock upon closing the lockable door 560 of the self-locking lockbox 570 such that additional locking action is not required by the user to lock the self-locking lockbox 570 when closed. Additionally, an opening pin 580 provided at the upper end 590 of the self-locking lockbox 570 and is designed to provide a spring force in an opening direction such that the force assists in the opening of the lockable door 560. Furthermore, the referencing end 510 of the locking latch securing mechanism 500 is rounded such that when closing the lockable door 560 the rounded referencing end enables the compression of the referencing end 510 of the securing rod 515.

The flowchart in FIG. 6 is an embodiment of the process in which the apparatus described in FIG. 1 through FIG. 5 are used whereby the self-locking lockbox, self-locks. The process within the flowchart represents three phases, unlocking phase, opening phase and locking phase and assumes the lockbox is already in closed and locked condition and is meant to represent the process wherein the self-locking lockbox is opened and then closed by a user where the self-locking lockbox locks. The process includes unlocking the lockbox, opening the lockbox and then closing the lockbox.

The first phase of the process as embodied in FIG. 6 is the unlocking phase. The unlocking phase consists of the user entering the preset combination by pushing in at least one pushbutton into the mechanical push button combination locking mechanism 611. The at least one pushbutton, pushes the pushbutton camshaft in the same direction whereby the locking arm holds the pushbutton camshaft in recessed 619 mode. The user then pushes on the lockable door 612 which drives the locking latch into the driving latch and translating the energy 613 from a lateral force into a vertical force.

The opening phase of the process is the next phase whereby the translated force drives the locking latch to slide towards the hinged end 631 thereby enabling it to clear the locking plate which is designed to restrict the door from opening and the rails slide releasing any pushbutton camshaft in recessed mode 633 thereby returning the pushbutton camshaft into non-recessed mode 634 and resetting the mechanical pushbutton combination locking mechanism such that a user must reenter the preset combination to open the lockbox when the lockable door is closed. The sliding of the locking latch causes the securing block to slide enabling the securing mechanism to restrict locking latch from sliding towards the locking end.

The next phase of the process includes the user ceasing to push the lockable door 661 and with the assistance of the opening pin the locking end of the lockable door travels away from the body. This travel causes the referencing end of the securing mechanism to uncompress as the lockable door egresses past the wall of the body 662. As the referencing end uncompresses it retracts the securing end securing mechanism thereby allowing the locking latch to travel back to the locking end of the lockable door once the locking latch clears the locking plate 663. The traveling of the locking plate back to the locking end of the lockable door places the locking latch back into locking condition.

As the user closes the lockable door the beveled edge of the locking plate drives the locking lever to slide down towards the hinged end of the lockable door such that the lockable lever clears the locking plate but does not clear enough to enable the securing end of the securing mechanism to extend. Once the locking latch clears the locking plate it returns back towards the locking end of the lockable door thereby causing the door to be closed and locked and additional locking action was not required by the user to lock the lockable self-locking lockbox.

The foregoing description of preferred embodiments of the present invention has been provided for the purposes of illustration and description. It is not intended to be exhaustive of to limit the invention to the precise forms disclosed. Many embodiments were chosen and described in order to best explain the principles of the invention and its practical application, thereby enabling others skilled in the art to understand the invention for various embodiments and with various modification that are suited to the particular use contemplated. It is intended that the scope of the invention by defined by the claims and their equivalents.

1. A self-locking lockbox with a mechanical pushbutton combination locking mechanism, the self-locking lockbox comprising:
a lockable door,
a mechanical pushbutton combination locking mechanism, for entry of a combination to open the lockable door;
an open condition; and
a closed condition, whereby the entry of a combination is not required to close the self-locking lockbox.

2. The self-locking lockbox of claim 1, wherein the entry of a combination is not required to lock the self-locking lockbox.

3. The self-locking lockbox of claim 1, wherein the mechanical pushbutton combination locking mechanism consists of:
a securing rod; and
a securing block, whereby the securing rod restricts the securing block from sliding when the self-locking lockbox is in an open condition.

4. (canceled)

5. The self-locking lockbox of claim 3, whereby the securing rod does not restrict the securing block from sliding when the self-locking lockbox is in a closed condition.

6. A method of locking a self-locking lockbox comprising the steps of:
unlocking the self-locking lockbox by entry of a combination;
opening the self-locking lockbox; and
closing the self-locking lockbox without re-entry of a combination.

7. A method of claim 6, wherein the self-locking lockbox consists of a mechanical pushbutton combination locking mechanism for entry of the combination for unlocking the self-locking lockbox.

8. A method of claim 7, wherein opening the self-locking lockbox further comprises of pressing a lockable door.

9. A method of claim 8, wherein closing the self-locking lockbox further comprises of pressing a lockable door.

10. A method of claim 9, wherein closing the self-locking lockbox, locks the self-locking lockbox.

11. (canceled)

12. (canceled)

13. (canceled)

14. (canceled)

15. (canceled)
